(19) United States
(12) Patent Application Publication
(10) Pub. No.: US 2010/0039986 A1
(43) Pub. Date: Feb. 18, 2010

(54) WIRELESS RADIO AND NETWORK

(75) Inventor: Matthew Jones, Weatherford, TX (US)

Correspondence Address: JACKSON WALKER, L.L.P., 112 E. PECAN, SUITE 2400, SAN ANTONIO, TX, 78205, US

(73) Assignee: PHAZAR CORP.

(21) Appl. No.: 12/191,113

(22) Filed: Aug. 13, 2008

(51) Int. Cl. H04Q 7/00

(52) U.S. Cl. 370/328

(57) ABSTRACT

In one aspect, a wireless radio may be used to connect to a wireless network, including a mesh network. For enhanced security, the radio may operate in silent mode whereby it does not advertise its presence until after it has detected another node. The radio may also provide its own subnetwork and provide network address translation to further enhance security and simplify network traffic.

### BACKGROUND

This specification relates to the field of wireless communication and more particularly to a wireless radio for use in a mesh network.

Wireless networking is a popular means of interconnecting many kinds of devices. For example, the Institute of Electrical and Electronics Engineers (IEEE) 802.11 family of standards specifies various protocols for wireless communication between devices. The IEEE 802.1 Is specification defines wireless interconnections for a type of ad-hoc network often referred to as a “mesh network.” In a mesh network, nodes interconnect wirelessly to provide links to other nodes. Traffic may be routed through several nodes to reach its destination, unlike a traditional wireless network, where each network device must be connected directly to a Wireless Access Point (WAP). In a mesh network, a device may be several nodes removed from a WAP. If connections to one device are lost, other devices may be able to keep nodes linked to each other.

### BRIEF DESCRIPTION OF THE DRAWINGS

FIG. 1 is a network diagram of an embodiment of a wireless mesh network;

FIG. 2 is a perspective view of an embodiment of a wireless mesh radio for use in a wireless mesh network;

FIG. 3 is a block diagram of selected components of an embodiment of a wireless mesh radio;

FIG. 4 is a block diagram disclosing selected elements of an embodiment of a wireless mesh radio wherein one antenna is configured to communicate with a wireless subnetwork and provide network address translation (NAT);

FIG. 5 is a network diagram disclosing an embodiment of a WAP mesh radio wherein one antenna connects the radio to a wireless mesh network, and the other antenna connects to a wireless subnetwork;

FIG. 6 is a flow chart showing selected steps in the logic of the NAT process performed on packets received from the subnetwork to be forwarded to the external network;

FIG. 7 is a flow chart showing selected steps in the logic for the NAT process performed on packets received from the external networks to be forwarded to the subnetwork;

FIG. 8 is a network diagram disclosing selected elements of the operation of wireless radios in silent mode;

FIG. 9 is a flow chart disclosing selected steps in the process of a wireless radio operating in silent mode;

FIG. 10 is a flow chart disclosing a method whereby a wireless radio may manage connections to other nodes; and

FIG. 11 is a network diagram disclosing a network in wish mesh nodes provide network address translation.

### SUMMARY OF THE INVENTION

In one aspect, a wireless radio may be used to connect to a wireless network, including a mesh network. For enhanced security, the radio may operate in silent mode whereby it does not advertise its presence until after it has detected another node. The radio may also provide its own subnetwork and provide network address translation to further enhance security and simplify network traffic.

### DETAILED DESCRIPTION OF THE EMBODIMENTS

A wireless mesh radio may be useful for connecting to a wireless mesh network and enhancing both the security of the network and the ease of configuration for devices attaching to the network. Although this specification specifically describes connecting to mesh networks, those of skill in the art will recognize that the devices and methods disclosed in this specification may also be useful for connecting devices to and configuring devices for other types of wireless and wired networks.

In one aspect, military users may need wireless devices that can be easily joined to secure wireless networks. In a military application, ease of configuration may be important because untrained personnel may be issued wireless radios to provide network access for equipment. Because these personnel are untrained, and because the network topology may be frequently changing, wireless radios may need to be capable of joining a network and automatically self-configuring with little or no user interaction. Security is also very important in this situation for two reasons. First, because of the strict chain of command in military culture, certain classes of users may need to be isolated from other classes of users. For example, general officers may communicate in one network, other officers in a second network, non-commissioned officers in a third network, and enlisted personnel in a fourth network. In that case, it may be important to isolate users on each network from users in the other networks so that, for example, privates do not have access to strategic planning applications intended for generals. Second, military networks may need to exclude rogue devices from secure networks. Rogue devices include any device that attempts to connect to a network that is not authorized to connect to the network. This may include deliberate attempts to breach security as well as devices that just happen to be near the network. Security measures for protecting a network may include encrypted communication, white lists, black lists, and means for hiding the presence of the network from rogue devices, such as silent mode operation as disclosed in this specification.

Network address translation (NAT) is another feature disclosed in this specification, useful for both enhancing security and configuring subnetworks. In NAT, a device acting as a wireless access point (WAP) may rewrite the header portions of packets to make it appear that all packets originate from the access point. If a wireless mesh radio is acting as a NAT device, it may have both wireless and wired subnetwork devices connected to it. These devices may communicate freely amongst themselves without NAT. But if any of the subnetwork devices need to communicate with the external network, the wireless radio will rewrite packet headers. This process helps to encapsulate network communication, and to ease configuration of subnetwork devices, and to conserve internet protocol (IP) addresses.

A wireless mesh radio and network will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance or example of an element and the un-hyphenated form of the reference numeral refers to the element generically or collectively. Thus, for example, 102-1 may refer to a “pen,” which may be an instance or example of the class of “writing implements.” Writing implements may be referred to collectively as “writing implements 102” and any one may be referred to generically as a “writing implement 102.”

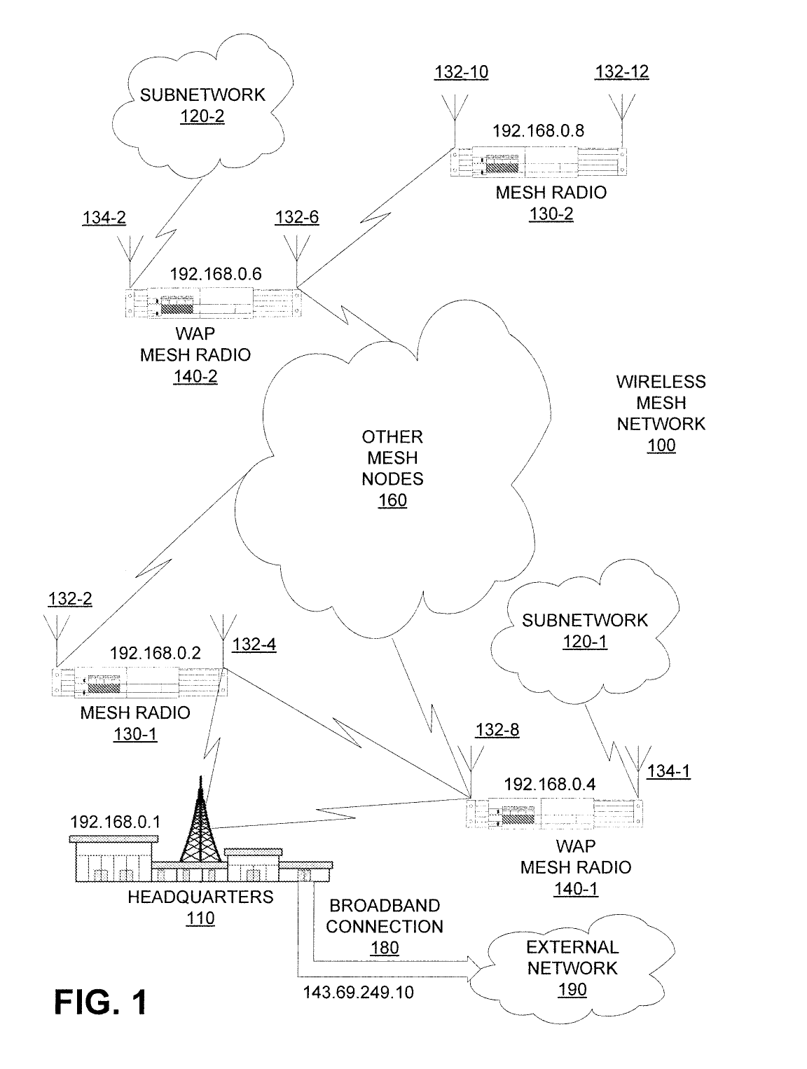

FIG. 1 is a network drawing disclosing selected elements of an embodiment of a wireless mesh network 100. Headquarters 110 is connected to an external network 190 through a broadband connection 180. On external network 190, headquarters 110 has an IP address of 143.69.249.10. A wireless antenna 112, which may be a radio tower, permits headquarters 110 to connect wirelessly to wireless mesh network 100. On wireless mesh network 100, headquarters 110 has IP address 192.168.0.1 and acts as a primary WAP. Wireless mesh network 100 may include other wireless devices acting as additional mesh nodes 160. For example, additional mesh radios 130 may be included in the wireless mesh network 100. Mesh radios 130 and WAP mesh radios 140 may sometimes be referred to as belonging to the super class of “mesh nodes,” meaning devices that operate in a mesh network. Although this specification deals primarily with wireless mesh nodes, those of skill in the art will recognize that a mesh node can, in principle, be adapted to operate over any communication medium, including Ethernet and other wired media where appropriate.

As shown, mesh radio 130-1 has IP address 192.168.0.2 on wireless mesh network 100. Mesh radio 130-1 may have mesh antennas 132-2 and 132-4. In this case, both antennas are configured as mesh antennas 132, meaning that each antenna 132 operates to route mesh network traffic. Mesh radio 130-2 has IP address 192.168.0.8 on wireless mesh network 100. Mesh radio 130-2 also has two mesh antennas 132-10 and 132-12. Mesh antenna 132-10 connects to additional mesh nodes 160 of the wireless mesh network 100. In this example, antenna 132-12 is not within range of any other mesh nodes, so antenna 132-12 is idle in this case. Also connected to wireless mesh network 100 are WAP mesh radios 140-1 and 140-2. Each WAP mesh radio has a mesh antenna 132 and a WAP antenna 134. A WAP antenna 134 is configured to provide wireless access to a subnetwork 120. WAP mesh radio 140-1 has mesh antenna 132-8, through which it connects to mesh nodes, and WAP antenna 134-1, through which it connects to subnetwork 120-1 and provides services as a WAP, including NAT. WAP mesh radio 140-2 is configured to be similar to WAP mesh radio 140-1 except that it has IP address 192.168.0.6 on wireless mesh network 100.

As FIG. 1 discloses, additional nodes 160 of wireless mesh network 100 may need to have access to a gateway. For example, headquarters 110 may be considered a gateway because it has a broadband connection to external network 190. But mesh radio 130-1 and WAP mesh radio 140-1 are the only devices with direct connections to headquarters 110. Subnetwork 120-1, WAP mesh radio 140-2 and its subnetwork 120-2, mesh radio 130-2, and the other mesh nodes 160 no direct access to headquarters 110. For example, for a packet from mesh radio 130-2 to reach headquarters 110, mesh radio 130 2 may route the packet through WAP mesh radio 140-2, other mesh nodes 160 and mesh radio 13-1. Once the packet reaches mesh radio 130-1, there are two possible routes for it to reach headquarters 100. First, the packet may travel to WAP mesh radio 140-1 and then to headquarters 100. Second, the packet may travel directly from mesh radio 130-1 to headquarters 100. Mesh radios 130 may include logic to select the shortest route to a packet's destination. In this case, the packet will normally be sent directly from mesh radio 130-1 to headquarters 100. If the link between mesh radio 130-1 and headquarters 110 is saturated, the packet may instead be routed through WAP mesh radio 140-1.

Devices may also be provided with self-healing logic to compensate for lost nodes. For example, if mesh radio 130-1 goes offline, then mesh radio 130-2 may send a packet, which will be relayed to WAP mesh radio 140-2, additional devices 160, WAP mesh radio 140-1, and then to headquarters 100. In this way, packets can still reach their destination even if an individual node goes offline. This capability may be very important to mesh networks, like military mesh networks, where nodes may be joined to and removed from the wireless mesh network 100 frequently.

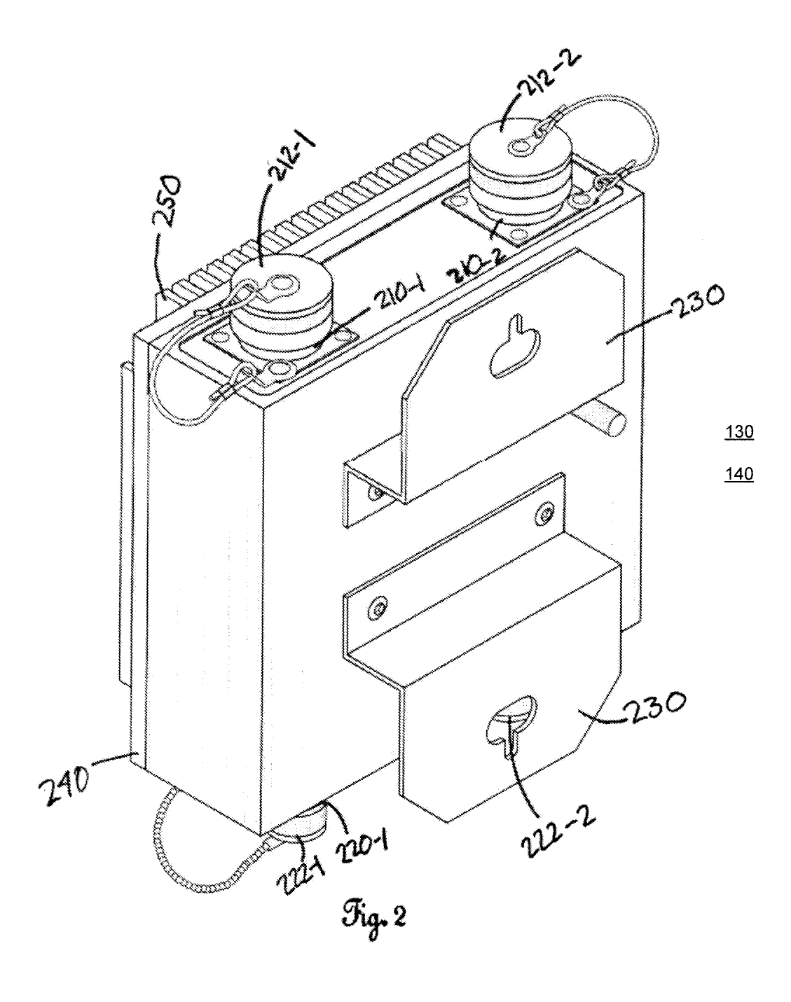

FIG. 2 is a perspective view of an embodiment of an exemplary form factor for a mesh node such as a wireless mesh radio 130 or WAP mesh radio 140. A mesh node such as mesh radio 130 or WAP mesh radio 140 may be encased by a ruggedized housing 240, which may include heat sink 250. Mounting brackets 230 may be provided to allow mounting of the wireless mesh radio 130 to a vehicle or other bulkhead. Power Over Ethernet (PoE) 210 connectors may be provided and may be protected by PoE covers 212. Antenna plugs 220 may also be provided, and may be protected by antenna plug covers 222.

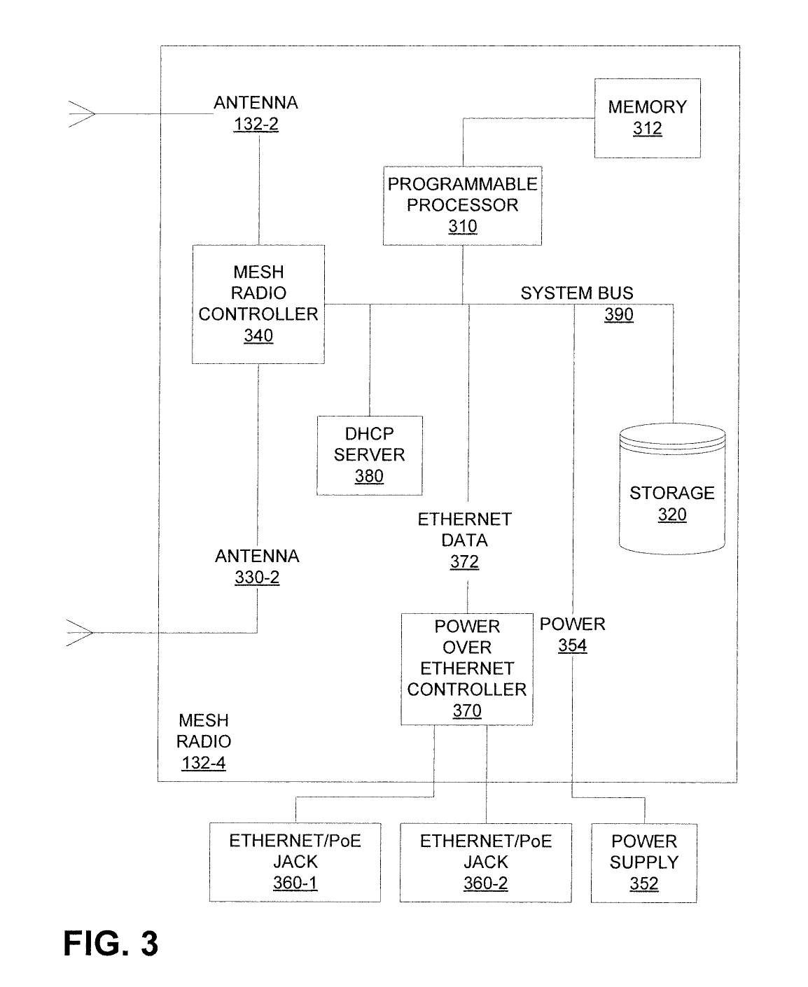

FIG. 3 is a block diagram disclosing selected elements of an embodiment of a wireless mesh radio 130. In this embodiment, both antennas 330 are configured for use with the wireless mesh network 100 (FIG. 1). Programmable processor 310 may be provided with a combination of volatile main memory 312 and/or non-volatile storage 320. Programmable processor 310 is communicatively coupled to a mesh radio controller 340, which may be any combination of hardware and/or software instructions adapted to allow the wireless mesh radio 130 to connect to the wireless mesh network 100 (FIG. 1). Power supply 352 provides power 354 to the system. Two Ethernetjacks 360 are provided, which may be either regular Ethernet or PoEjacks. A controller may be provided which may be a PoE controller 370. PoE controller 370 may implement the IEEE 802.3 PoE protocol or any other PoE mechanism. PoE controller 370 may also provide standard Ethernet communication functions. PoE controller 370 provides Ethernet data 372 to the system. A dynamic host configuration protocol (DHCP) server 380 may also be provided to provide address configuration for any connected subnetworks 120 (FIG. 1).

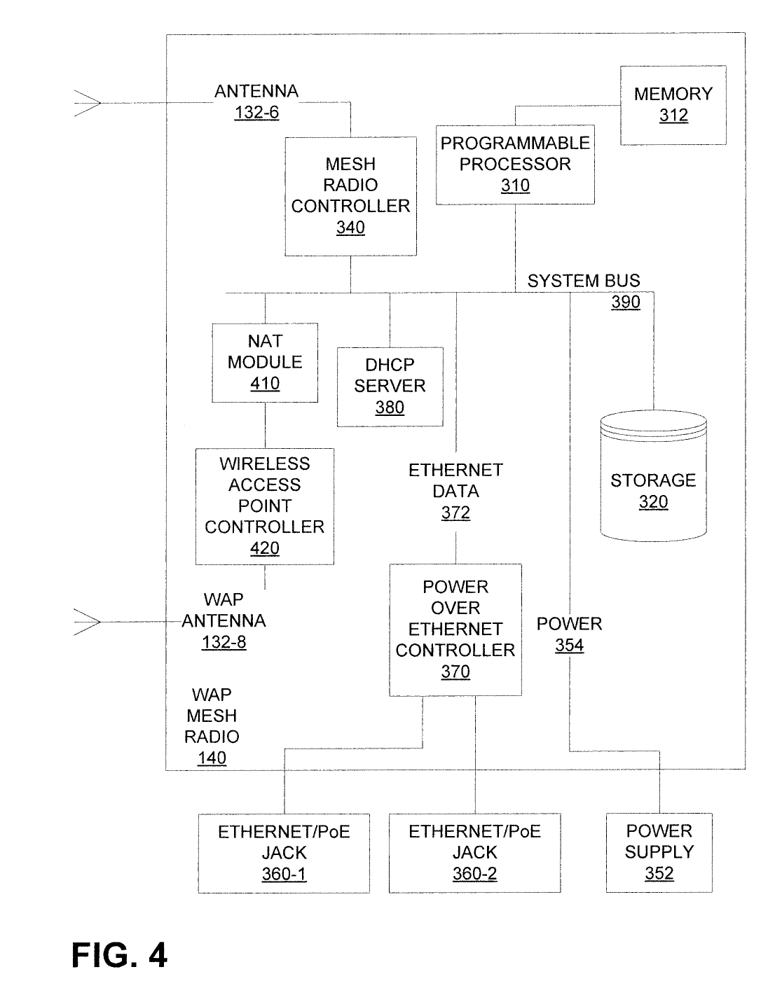

FIG. 4 is a block diagram of selected elements of an embodiment of a WAP mesh radio 140. WAP mesh radio 140 is similar to the mesh radio 130 of FIG. 3. But one antenna 132 is configured as a WAP antenna 132-8. A WAP controller 420 is provided to allow the WAP mesh radio 140 to serve as a WAP. A NAT module 410 is also provided, which provides the NAT function. NAT module 410 may be any combination of hardware and/or software instructions adapted to provide network address translation.

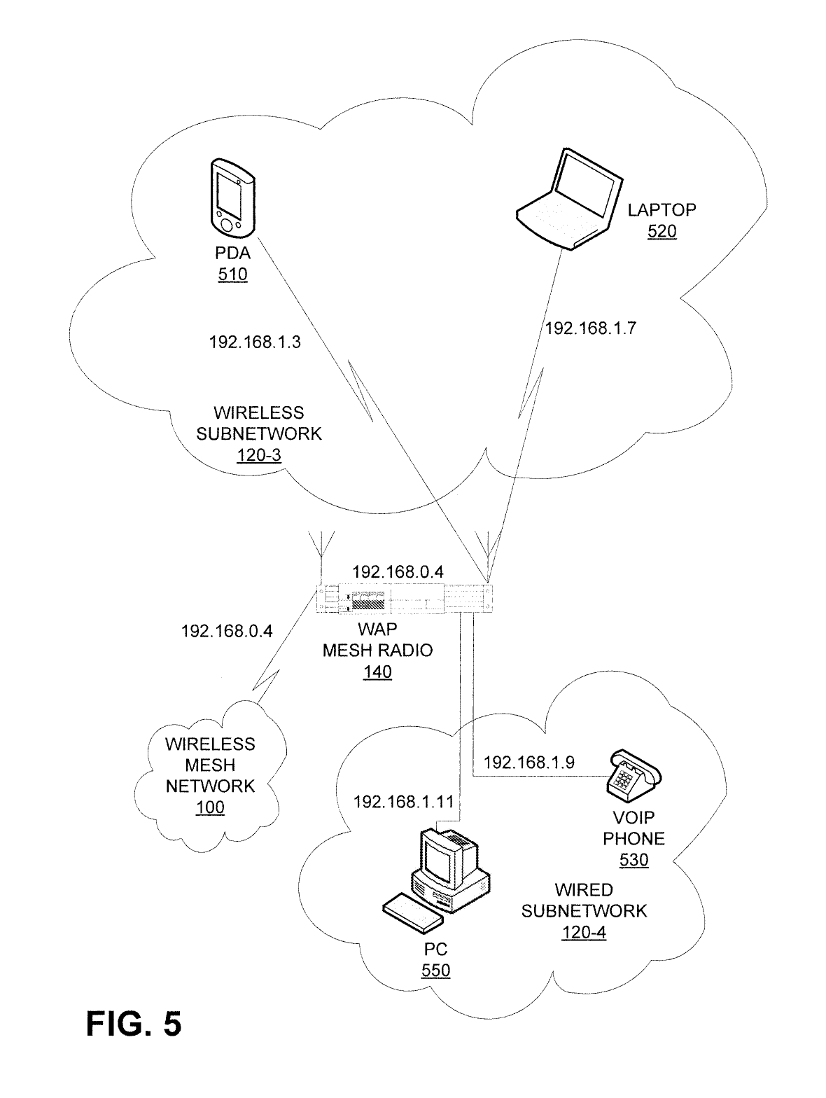

FIG. 5 is a network diagram showing a WAP mesh radio 140 connected to a wireless mesh network 100 and a subnetwork 120, including a wireless subnetwork 120-3 and wired subnetwork 120-4. WAP mesh radio 140 has IP address 192.168.0.4 on wireless mesh network 100. In this example, devices on wireless subnetwork 120-3 have IP addresses in the 192.168.1.x range. For example, wireless PDA 510 has IP address 192.168.1.3 and a laptop 520 has IP address 192.168.1.7. There are also devices on the wired subnetwork 120-4. For example, a personal computer (PC) 550 has address 192.168.1.11 and a Voice-Over-IP (VoIP) phone has address 192.168.1.9. Both of these are connected to a PoE connector 360 (FIG. 4). There is also a wireless router 540 in wireless subnetwork 120-3. Wireless router 540 has IP address 192.168.1.5. Wireless router 540 may provide wireless access to another subnetwork (not shown), and may provide NAT services for its own subnetwork. In fact, wireless router 540 may be another NAT-enabled mesh radio 140. The NAT method disclosed in the present specification enables devices to perform multi-layered network address translation so that misconfiguration is not a problem.

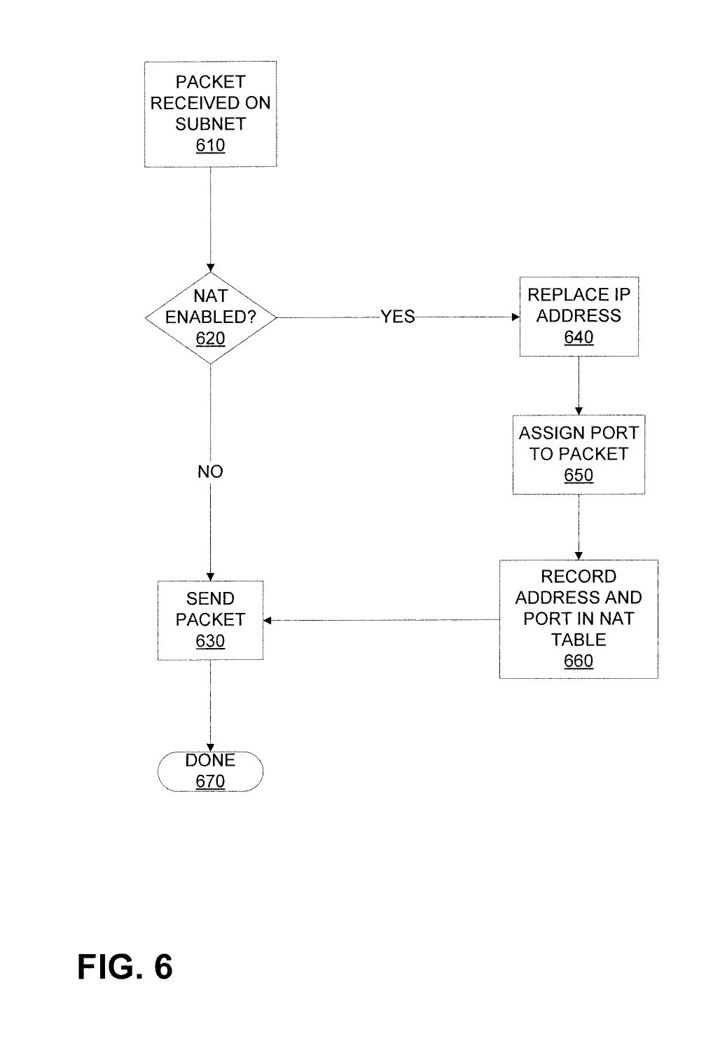

FIG. 6 is a flow chart showing selected steps in the process of performing NAT on a packet received from subnetwork 120 (FIG. 4) and directed to an external network. In block 610, a packet is received from subnetwork 120 (FIG. 4). In block 620 there is a check to see whether NAT is enabled. If NAT is not enabled, then in block 630, the packet is forwarded on to the network. In block 640, if NAT is enabled, then the packet's header is rewritten. A typical header, as known in the art, includes two “sockets,” with each socket being an IP Address:Port pair. The first socket identifies the source and the second socket identifies the destination. An example is shown below:

TABLE 1
Example Packet Header

| Source Socket | | Destination Socket | |
|---|---|---|---|
| Source IP | Source Port | Destination IP | Destination Port |
| 192.168.10.3 | 2040 | 85.45.224.8 | 80 |

In a more general sense, a header may be any data structure that uniquely identifies a network device and includes a second value that can be used as a reference value. A port number may be assigned in block 650 and may be selected from a number of available ports to uniquely identify the packet. The IP address portion of the header is replaced with the IP address of the WAP mesh radio 140, and in block 660 an entry is made in a table associating the port number of the packet with the IP address of the subnetwork device that originated the packet. In some embodiments, the port number may also be replaced. Then, in block 630, the packet is delivered to the external network.

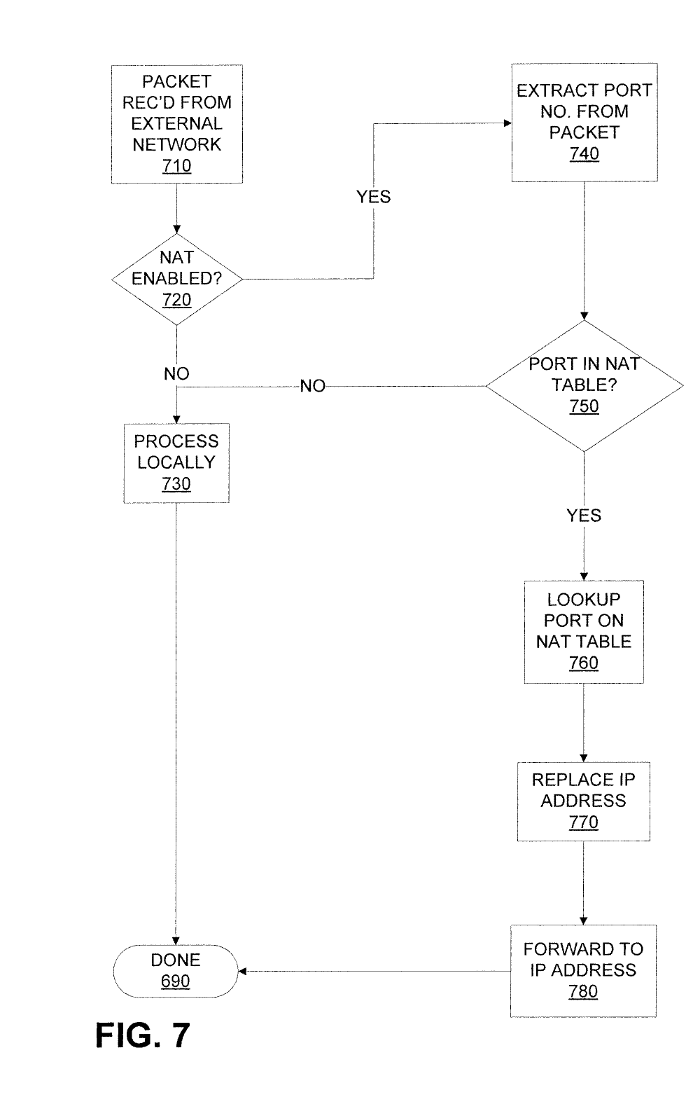

FIG. 7 is a flow chart showing selected steps in the process of performing NAT on packets received from the external network and directed to the subnetwork. In block 710, the packet is received from the external networks, and in block 720 there is a check to see whether NAT is enabled. If NAT is not enabled, the packet is processed locally in block 730. If NAT is enabled, then in block 740, the port number is extracted from the packet header. In block 750, there is a check to see whether the port number has been recorded in the NAT table. If it has not, then it is assumed that the packet is directed to the local host and in block 730 is processed locally. In block 750, if the port number is in the NAT table, then in block 760, the NAT table is checked to find the IP address associated with that port. In block 770, the header is rewritten and the IP address is replaced with the IP address of the destination device on the subnetwork. In block 780, the packet is forwarded to the destination device on the subnetwork.

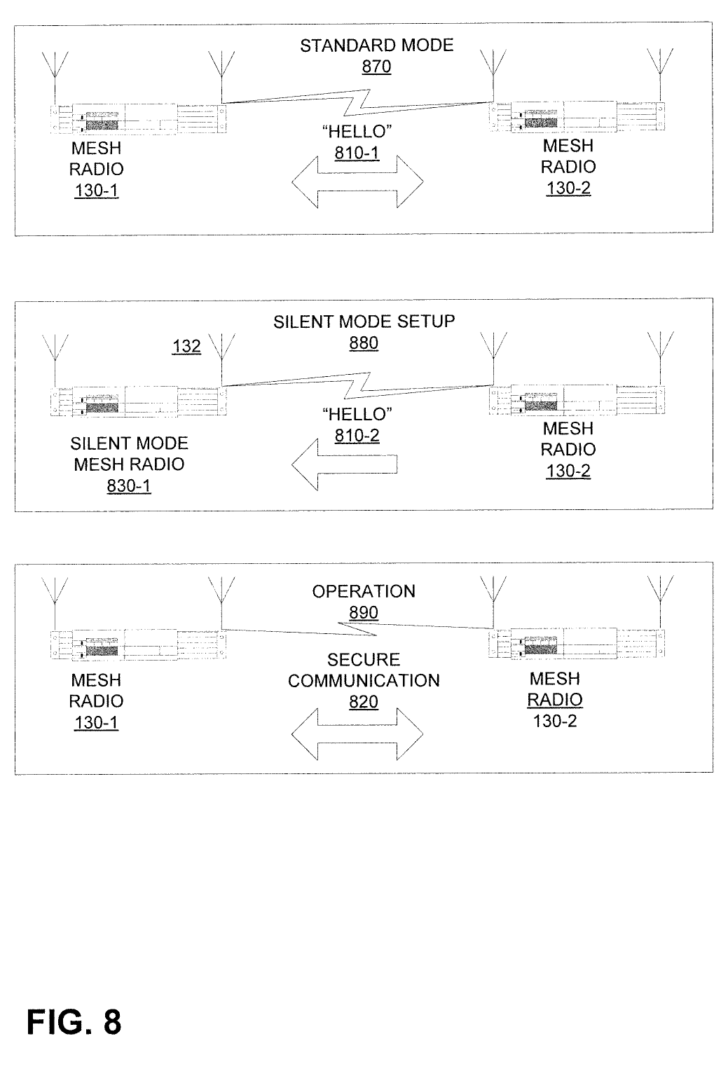

FIG. 8 is a network diagram showing the operation of a silent mode mesh radio 130. Block 870 shows, for purposes of comparison, the operation of mesh radio 130 in standard mode. When the mesh radio operates in standard mode, mesh radio 130-1 and mesh radio 130-2 both send “HELLO” beacons 810-1. These HELLO beacons 810-1 are broadcast by both mesh radios 130 at regular intervals. This allows each mesh radio 130 to recognize that the other is present.

Block 880 shows how silent mode communication is set up. In this case, silent mode mesh radio 830-1 is not broadcasting HELLO beacons 810-2. Silent mode mesh radio 830-1 is simply listening on its antennas 132. Mesh radio 130-2 is a standard mode mesh radio, which may not yet be configured to join to any network. Mesh radio 130-2 broadcasts HELLO beacons 810-2 at regular intervals. Silent mode mesh radio 830-1 will receive HELLO beacons 810-2 and may determine from the HELLO beacons 810-2 that mesh radio 130-2 is a device authorized to join the mesh network. Silent mode mesh radio 830-1 may then send configuration instructions to mesh radio 130-2, so that mesh radio 130-2 can assume the proper network configuration.

Block 890 shows the operation of the mesh radios while in silent mode. Mesh radio 130-1 and mesh radio 130-2 have established communication at this point, and mesh radio 130-2 has been properly configured. Now secured communication 820, which may be encrypted or otherwise secured, will pass between mesh radio 130-1 and mesh radio 130-2. While mesh radio 130-1 and mesh radio 130-2 are in secure communication, they may or may not broadcast HELLO beacons 810-2. In some embodiments, they may broadcast encrypted HELLO beacons so that rogue devices cannot understand them. In other embodiments, they may broadcast unencrypted HELLO beacons but revert to silent mode when they are no longer connected. In yet other embodiments, they may not broadcast HELLO beacons at all, but may instead rely on other types of periodic communication to each detect that the other is present. In some embodiments, mesh radio 130-1 and mesh radio 130-2 can send encrypted packets that serve the function of a HELLO beacon 810 so that mesh radio 130-1 and mesh radio 130-2 each know that the other is still connected to the network.

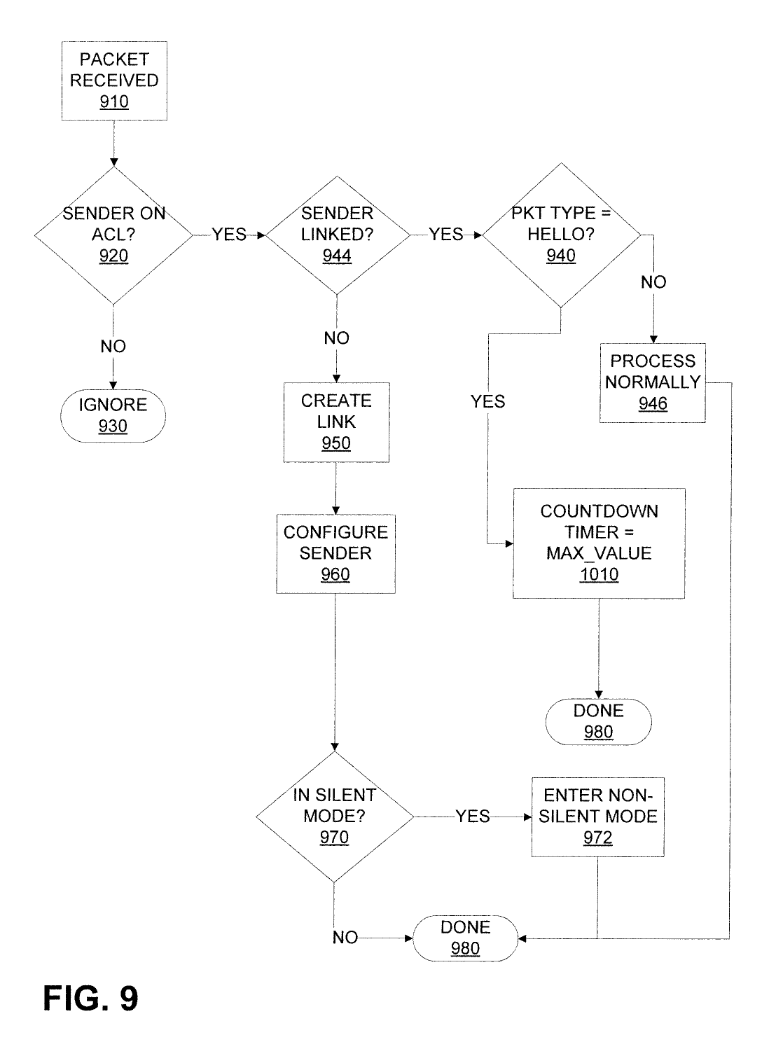

FIG. 9 is a flow chart disclosing selected steps in the process of a wireless mesh radio 130. Managing connections with other wireless mesh radios 130 in the wireless mesh network 100. In block 910 a packet is received and in block 920 there is a check to see whether the sender is on an access control list (ACL). If the sender is not on the ACL, then the sender is considered a rogue device and in block 930 the packet is ignored. If the sender is on the ACL, then in block 944 there is a check to see whether the sender is already linked to the wireless mesh network 100. If the sender is not linked, then in block 950, a link is created for the new device, and in block 960, in some embodiments, the first wireless mesh radio 130 will configure the other wireless mesh radio 130. In block 970, there is a check to see whether the wireless mesh radio 130 is operating in silent mode. If it is, then in block 972, the wireless mesh radio 130 may enter non-silent mode for purposes of the communication with the second wireless mesh radio 130. This may be accomplished by any of the methods discussed in reference to FIG. 8 above. Returning to block 944, if the sender is linked, then in block 940 the processor checks to see whether the packet type is a HELLO. If the packet is a HELLO packet, then a countdown timer will be reset to its maximum value in block 1010. In block 940, if the packet type is not a HELLO packet, then in block 946, the packet is processed normally.

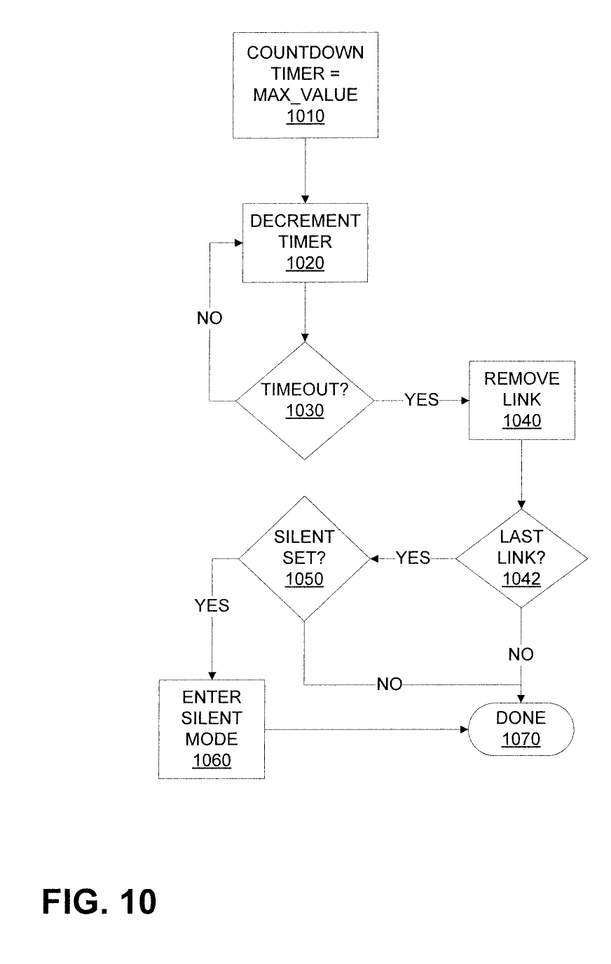

FIG. 10 is a flow chart showing selected steps by which a first wireless mesh radio 130-1 determines whether a second wireless mesh radio 130-2 is still connected to the wireless mesh network 100. In block 1010, a countdown timer is initialized to its maximum value. In block 1020, the timer is decremented. In block 1030 there is a check to see whether the timer has decremented to 0. If not, then the timer continues to decrement. It should be noted, that if HELLO packets are received from second wireless mesh radio 130-2, then the timer may be reset to its maximum value as disclosed in FIG. 9 so that the countdown time will not reach 0 while the second mesh radio 130-2 is connected. Returning to block 1030, if the countdown timer has reached zero, then in block 1040 the link for second wireless mesh radio 130-2 is removed, and in block 1042 there is a check to see whether this was the last linked wireless mesh radio 130. If this was not the last wireless mesh radio 130 then no further action is taken. If it is the last wireless mesh radio, then in blocks 1050 there is a check to see whether silent mode is set. If silent mode is set, then in block 1060 the wireless mesh radio 130-1 enters silent mode. If silent mode is not set, then the process is complete.

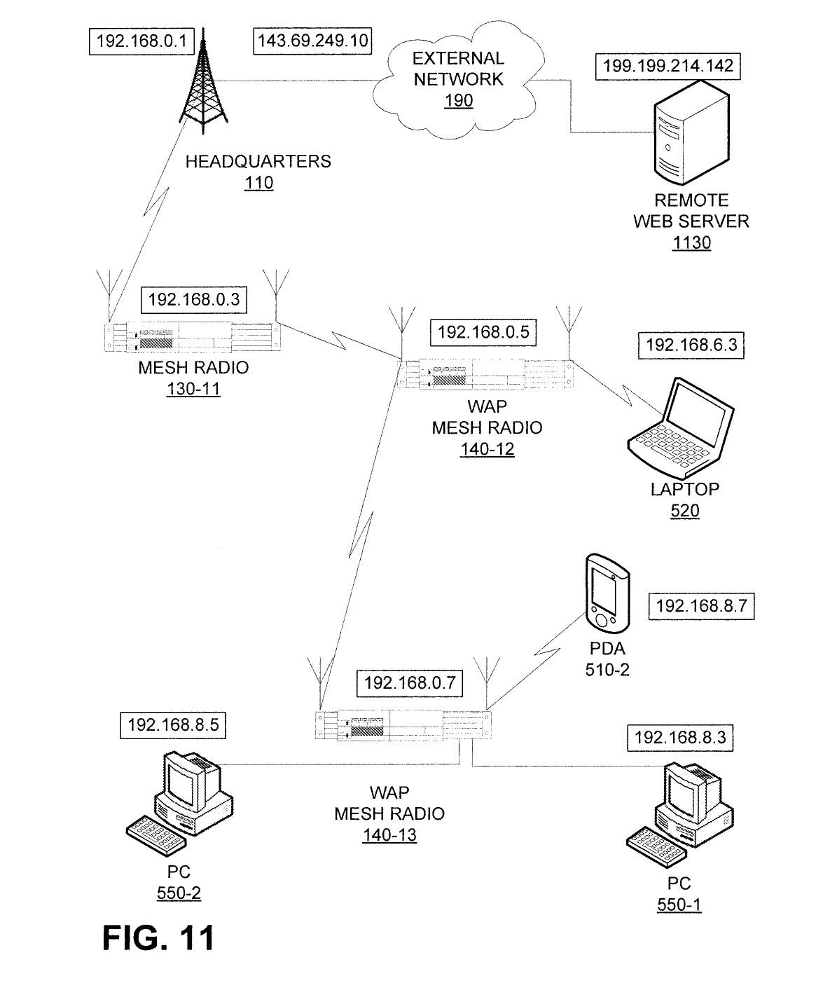

FIG. 11 is a network diagram disclosing an exemplary mesh network wherein certain mesh nodes perform NAT. Although this network will be described in terms of a definite arrangement, a person having skill in the art will recognize that the arrangement is only one of may possible configurations that can be achieved with such a network. In this embodiment, headquarters 110 has a broadband network connection 180 (FIG. 1) to external network 190. On external network 190, headquarters 110 has public IP address 143.69.249.10. Headquarters 110 also provides wireless access to a private subnetwork, on which it has IP address 192.168.0.1. When mesh radio 130-11 connects to headquarters 110, mesh radio 130-11 receives IP addresss 192.168.0.3. When WAP mesh radio 140-12 connects to mesh radio 130-11, mesh radio 130-11 sends configuration instructions that provide WAP mesh radio 140-12 with IP address 192.168.0.5. It should be noted that the IP address for WAP mesh radio 140-12 is in the address block used by the wireless mesh network 100. WAP mesh radio 140-12 is configured to operate one of its antennas as a WAP antenna. The WAP will reserve a block of addresses for its subnetwork and assign those to devices that connect. So when laptop 520 connects to WAP mesh radio 140-12, laptop 520 receives IP address 192.168.6.3, which is only visible on the WAP subnetwork. But when another mesh radio, such as WAP mesh radio 140-13 connects to the WAP subnetwork, it does not receive an IP address in the WAP subnetwork block. Rather, it receives an IP address in the wireless mesh network 100 IP block, for example, 192.168.0.7. This ensures that mesh nodes can always recognize WAP mesh radio 140-13, even if, for example, WAP mesh radio 140-12 goes offline and WAP mesh radio 140-13 then needs to connect directly to mesh radio 130-11.

WAP mesh radio 140-13 provides a WAP subnetwork, so that when PDA 510-12 connects, it receives IP address 192.168.8.7, which is on the address block reserved for the subnetwork. WAP mesh radio 140-13 can also provide a wired subnetwork on its two PoE connectors, so that PC 550-1 can connect and receive subnetwork address 192.168.8.3, and PC 550-1 can connect and receive subnetwork address 192.168.8.5.

This configuration creates a hierarchy with Headquarters 110 at the top. At the next level down are mesh radios 130 and WAP mesh radios 140. Finally, there are devices that are connected to subnetworks of WAP mesh radios 140. Note that although WAP mesh radio 140-13 and laptop 520 are both connected to the mesh network 100 through WAP mesh radio 140-12, WAP mesh radio 140-13 is logically higher in the hierarchy because it has received an IP address on wireless mesh network 100. So while WAP mesh radio 140-13 can dynamically connect to another mesh node if its connection to WAP mesh radio 140-12 is lost, laptop 520 cannot. Laptop 520 is entirely dependent upon WAP mesh radio 140-12 and is not visible to wireless mesh network 100.

Each mesh node that is configured to provide network address translation will maintain a NAT table to identify which packets belong to which device. For example, WAP mesh radio 140-13 may receive packets from its three subnetwork devices with the following headers, with each header including a source socket and destination socket.

TABLE 2
Request Packet Headers

| Source IP | Source Port | Destination IP | Destination Port |
|---|---|---|---|
| 192.168.8.3 | 2020 | 199.199.214.142 | 80 |
| 192.168.8.5 | 3020 | 64.233.171.83 | 25 |
| 192.168.8.7 | 4020 | 17.251.200.74 | 20 |

Before WAP mesh radio 140-13 forwards these packets to mesh network 100, it will rewrite the headers so that the packets appear to have come from itself. For example, the rewritten headers may be as follows:

TABLE 3
Rewritten Request Packet Headers

| Source IP | Source Port | Destination IP | Destination Port |
|---|---|---|---|
| 192.168.0.7 | 2030 | 199.199.214.142 | 80 |
| 192.168.0.7 | 3030 | 64.233.171.83 | 25 |
| 192.168.0.7 | 4030 | 17.251.200.74 | 20 |

WAP mesh radio 140-13 also creates a NAT table allowing it to trace the packets based on port number.

TABLE 4
Mesh Radio 140-13 NAT Table

| Source IP | Source Port | Assigned IP | Assigned Port |
|---|---|---|---|
| 192.168.8.3 | 2020 | 192.168.0.7 | 2030 |
| 192.168.8.5 | 3020 | 192.168.0.7 | 3030 |
| 192.168.8.7 | 4020 | 192.168.0.7 | 4030 |

When WAP mesh radio 140-13 receives responses to the packets sent, the packet headers may be as follows:

TABLE 5
Response Packet Headers

| Source IP | Source Port | Destination IP | Destination Port |
|---|---|---|---|
| 199.199.214.142 | 80 | 192.168.0.7 | 2030 |
| 64.233.171.83 | 25 | 192.168.0.7 | 3030 |
| 17.251.200.74 | 20 | 192.168.0.7 | 4030 |

Based on the NAT table, WAP mesh radio 140-13 will be able to identify the true destination for each packet, and will rewrite the headers accordingly and then send the packets.

TABLE 6
Rewritten Response Packet Headers

| Source IP | Source Port | Destination IP | Destination Port |
|---|---|---|---|
| 199.199.214.142 | 80 | 192.168.8.3 | 2020 |
| 64.233.171.83 | 25 | 192.168.8.5 | 3020 |
| 17.251.200.74 | 20 | 192.168.8.7 | 4020 |

Because the aliased IP address and port assignments shown above are maintained and traceable, a packet can be reliably delivered to its true intended target. And because the WAP mesh radio 140 has an IP address that is visible on the mesh network, the packets can be properly routed even if the WAP mesh radio 140 providing NAT is several layers deep in the physical network topology. For example, WAP mesh radio 140-13 is two layers removed from headquarters 110 because its traffic must be routed through WAP mesh radio 140-12 and mesh radio 130-11 before reaching headquarters 100. But because WAP mesh radio 140-12 has an IP address recognized by the mesh network, other mesh nodes can forward its traffic without providing NAT services or otherwise processing the packets. So any traffic originating from WAP mesh radio 140-13 or its subnetwork will not be altered by other mesh nodes. This means that the traffic will be properly delivered even if the network topology changes during the exchange. For example, if WAP mesh radio 140-12 went offline after the request packets were sent, and if WAP mesh radio 140-13 successfully connected to mesh radio 130-11, the response packets would be properly delivered to WAP mesh radio 140-13. Likewise, if WAP mesh radio 140-12 moved slightly out of range of WAP mesh radio 140-13 after the request packets were sent, and if another mesh radio 130 came online between the two, both could connect to the new mesh radio 130, which could then receive the response packets and deliver them to WAP mesh radio 140-13.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A wireless radio configured to operate in silent mode in a wireless network, the wireless radio comprising:
a programmable processor communicatively coupled to a wireless mesh network by an antenna;
wherein the processor is programmed to
remain silent until the processor detects a presence of a second wireless radio; and
communicate with the second wireless radio while the second wireless radio is present;

2. The wireless radio of claim 1 wherein the wireless radio is programmed to remotely configure the second wireless radio.

3. The wireless radio of claim 1 wherein communication with the second wireless radio is encrypted.

4. The wireless radio of claim 1 further comprising a second antenna, wherein the second antenna is configured to communicatively couple a wireless subnetwork to the wireless mesh network.

5. The wireless radio of claim 1 further comprising a wired connector adapted to communicatively couple a wired subnetwork to the wireless mesh network.

6. The wireless radio of claim 5 wherein the wired connector is a power over Ethernet connector.

7. A wireless mesh network wherein the wireless radio of claim 1 forms a node in the network.

8. A computer-readable medium in a mesh node operating in silent mode, the medium containing a software program comprising instructions to:
silently detect the presence of a second mesh node;
send instructions to instruct the second mesh node to assume a network configuration and to enter silent mode; and
conduct encrypted communication with the second mesh node while the second mesh node is present.

9. The computer-readable medium of claim 8 wherein the instructions to detect the presence of a second mesh node include instructions to:
receive a “HELLO” beacon identifying the second mesh node; and
determine that the second mesh node is authorized to connect.

10. The computer-readable medium of claim 8 wherein the software program further comprises instructions to simultaneously listen for and communicate with additional mesh nodes.

11. The computer-readable medium of claim 8 wherein the software program further comprises instructions to detect that a mesh node attempting to connect is an unauthorized mesh node and to ignore the unauthorized mesh node.

12. A mesh node providing network address translation, the mesh node comprising:
a mesh interface communicatively coupling the mesh node to a mesh network;
a subnetwork interface communicatively coupling the mesh node to a subnetwork; and
a programmable processor configured to
translate network traffic received from the subnetwork for use with the mesh network; and
translate network traffic received from the mesh network for use with the subnetwork.

13. The mesh node of claim 12 wherein the mesh network is a wireless mesh network.

14. The mesh node of claim 12 wherein the subnetwork includes a wired network.

15. The mesh node of claim 14 wherein the subnetwork interface is a power over Ethernet connector.

16. The mesh node of claim 12 wherein the subnetwork is a wireless network and the subnetwork interface is a second antenna.

17. The mesh node of claim 12 wherein the programmable processor translates network traffic by:
rewriting packet headers of packets received from the subnetwork by replacing an IP address in the packet header with its own IP address; and
rewriting packet headers of packets directed to the subnetwork by replacing an IP address in the header with an IP address for a device connected to the subnetwork.

18. A wireless mesh network including mesh nodes, wherein at least some of the mesh nodes are mesh nodes as in claim 12.

19. A computer-readable medium in a mesh node connected to a mesh network and providing network address translation to a private subnetwork, the computer-readable medium containing a software program comprising instructions to:
receive a first packet from a device connected to the private subnetwork, the first packet including a source header, the source header comprising a reference value and an internet protocol (IP) address identifying the device;
rewrite the source header by replacing the IP address with an IP address identifying the mesh node to the mesh network;
create a record associating the reference value with the IP address of the device;
deliver the first packet to the mesh network;
receive a second packet from the mesh network, the second packet being a response to the first packet and including a destination header, the destination header comprising a reference value and the IP address of the mesh node;
read the record associating the reference value with the IP address of the device;
rewrite the destination header by replacing the IP address of the destination header with the IP address of the device; and
deliver the second packet to the device;
whereby the mesh node is enabled to provide effective network address translation in configurations where the mesh node is required to connect to the mesh network through at least one other mesh node.

20. The computer-readable medium of claim 19 wherein the reference value is a port number.

21. The computer-readable medium of claim 19 wherein the record is a table.

22. The computer-readable medium of claim 19 wherein the instructions to rewrite the source header further comprise instructions to replace the reference number with a new reference number, and wherein the reference number in the record is the new reference number.

23. A wireless mesh radio configured to operate as a mesh node of a wireless mesh network, the wireless mesh radio comprising:
a programmable processor;
a first antenna configured to communicatively couple the programmable processor to the wireless mesh network;
a second antenna configured to communicatively couple the programmable processor to a private subnetwork; and
a power over Ethernet connector configured to communicatively couple the programmable processor to the private subnetwork;
wherein the programmable processor is configured to:
communicate with the wireless mesh network as a silent mesh node such that the wireless mesh radio does not broadcast self-identifying beacons and listens for other wireless mesh radios broadcasting self-identifying beacons;
upon detection of the second wireless mesh radio broadcasting a self-identifying beacon and determination that the second wireless mesh radio is an authorized node, initiate communication with the second wireless mesh radio, send initialization instructions to the second wireless mesh radio, including providing the second wireless mesh radio an internet protocol (IP) address in an address space used by the wireless mesh network, and to encrypt its communication with the second wireless mesh radio;
detect when an unauthorized wireless device attempts to connect to the first wireless mesh radio and to ignore the connection attempt; and
provide network address translation for the second wireless mesh radio by:
receiving a first packet from a subnetwork device connected to the private subnetwork, the first packet including a first header comprising the IP address of the subnetwork device and a first port number;
rewriting the first header by substituting an IP address of the first wireless mesh radio for the IP address of the subnetwork device and substituting a second port number for the first port number;
creating a record in a table associating the second port number with the IP address of the subnetwork device and the first port number;
delivering the first packet to the wireless mesh network;
receiving a second packet from the wireless mesh network, the second packet being a response to the first packet and including a second header comprising the IP address of the first wireless mesh radio and the second port number;
locating the record in the table wherein the second port number is associated with the IP address of the subnetwork device and the first port number;
rewriting the second header by substituting the IP address of the subnetwork device for the IP address of the first wireless mesh radio and the first port number for the second port number; and
delivering the packet to the subnetwork device.
